(19) United States
(12) Patent Application Publication
(10) Pub. No.: US 2004/0024992 A1
(43) Pub. Date: Feb. 5, 2004

(54) Decoding method for a multi-length-mode instruction set

(76) Inventor: Shan-Chyun Ku, Hsinchu (TW)

Correspondence Address: RABIN & Berdo, PC, 1101 14TH STREET, NW, SUITE 500, WASHINGTON, DC, 20005, US

(21) Appl. No.: 10/210,075

(22) Filed: Aug. 2, 2002

(51) Int. Cl. G06F 9/30

(52) U.S. Cl. 712/210

(57) ABSTRACT

A decoding method for a multi-length-mode instruction set. The decoding method includes the steps of: rearranging a fixed length instruction into an instruction-partitioned part and a zero-filling part; decoding the rearranged instruction as multiple fields based on the rearranged instruction format requirement; and choosing one field from the multiple fields through a multiplexer as the destination register's content according to the length of the desired instruction part. Therefore, the decoding method can support various lengths of instruction sets using an additional multiplexer with a very small additional memory space.

### BACKGROUND OF THE INVENTION

1. Field of the Invention

The invention relates to an instruction decoding method, especially to a decoding method for a multi-length-mode instruction set, to support various lengths of instruction sets with a very small additional memory space.

2. Description of Related Art

Data processing operates with a processor core acting under control of program instruction words, which when decoded serve to generate core control signals to control the different elements with the processor to perform the necessary operations to achieve the processing specified by the program instruction word.

Many embedded systems, such as ARM series, use fixed length instruction sets for data processing operation because they require less space when the design of instruction decoder, instruction fetcher and PC address calculator proceeds. However, in the instruction encoding stage, the longest instruction length required in encoding becomes a standard fixed length for all instruction encoding. This relatively wastes memory space, especially for those smaller instructions, for example, MOV, ADD, or SUB and so on. Accordingly, an example of saving the cited fixed length instruction set is given.

In some ARM series, for example, ARM 7TDMI, ARM 9TDMI and ARM 10TDMI, the instruction set is divided into 16- and 32-bit instruction length modes. The 16-bit instruction length mode indicates 16-bit Thumb instructions and the 32-bit instruction length mode indicates 32-bit ARM instruction. As such, ARM can obtain higher code density and provide high performance from narrow memory.

FIG. 1 schematically illustrates a first example of a typical 16-to-32-bit ARM instruction mapping. As shown in FIG. 1, the thick lines originate from few bits within the 16-bit instruction that require mapping into the assigned bit positions within the 32-bit instruction. The operands Rn′, Rd′ and Immediate within the 16-bit instruction require padding at their most significant end with zeros to fill the 32-bit instruction. This padding is needed as a result of the 32-bit instruction operands having a greater range than the 16-bit instruction operands. It will be seen from the generalized form of the 32-bit instruction given at the bottom of FIG. 5 that the 32-bit instruction allows considerably more flexibility than the subset of that instruction represented by the 16-bit instruction. For example, the 32-bit instructions are preceded by conditional field Cond that sets the instruction do not carry any conditional field in themselves and the conditional field of the 32-bit instructions to which they are mapped to a value of “1110” equivalent to the conditional execution state “always”.

FIG. 2 schematically illustrates another such instruction mapping. As shown in FIG. 2, the 16-bit instruction in this case is a different type of Load/Store instruction from that illustrated in FIG. 5. However, this instruction is still a subset of the single data transfer instruction of the 32-bit instruction set. An example of a 32-bit instruction set including the cited single data transfer instruction is shown in FIG. 3, where eleven different types of instructions for the 32-bit instruction set are in turns:

1. Data processing PSR transfer;

2. Multiply;

3. Single data Swap;

4. Single data transfer;

5. Undefined;

6. Block data transfer;

7. Branch;

8. Co-processor data transfer;

9. Co-processor data operation;

10. Co-processor register transfer; and

11. Software interrupt.

A full description of this instruction set may be found in any Data Sheet of the ARM processor series produced by Advanced RISC Machines Limited.

For implementation of the cited 16-to-32 instruction mapping, a decoding architecture including a translator and a 32-bit decoder for each instruction set as shown in FIG. 4 (for simplification, only a unit for an instruction set is presented) or including two decoders to respectively decode the 16- and 32-bit instruction set (not shown) is necessary, so that the 32-bit decoder decodes the input instructions to create the outputs Rd, Rn, Immediate, OP, Cond, and so on (FIGS. 1-3) for the ARM core (not shown). However, instruction decoders and translators are relatively complex and large circuit elements. The limited space in an integrated circuit will be occupied by additional decoders or translators so as to reduce other possible functionalities offering to the integrated circuit.

### SUMMARY OF THE INVENTION

Accordingly, an object of the invention is to provide a decoding method for multi-length-mode instruction set, to support various lengths of instruction sets with a very small additional memory space.

The invention provides a decoding method for multi-length-mode instruction set, which uses a multiplexer for each instruction set to achieve the decoding of multi-length-mode instruction set without using additional translator or decoder. The decoding method includes the steps of: rearranging a fixed length instruction into an instruction-partitioned part and a zero-filling part; decoding the rearranged instruction as multiple fields based on the rearranged instruction format requirement; and choosing one field from the multiple fields through a multiplexer as an output to the destination register according to the length of the instruction-partitioned part.

### BRIEF DESCRIPTION OF THE DRAWINGS

FIG. 1 schematically illustrates a first example of a typical 16-to-32-bit instruction mapping;

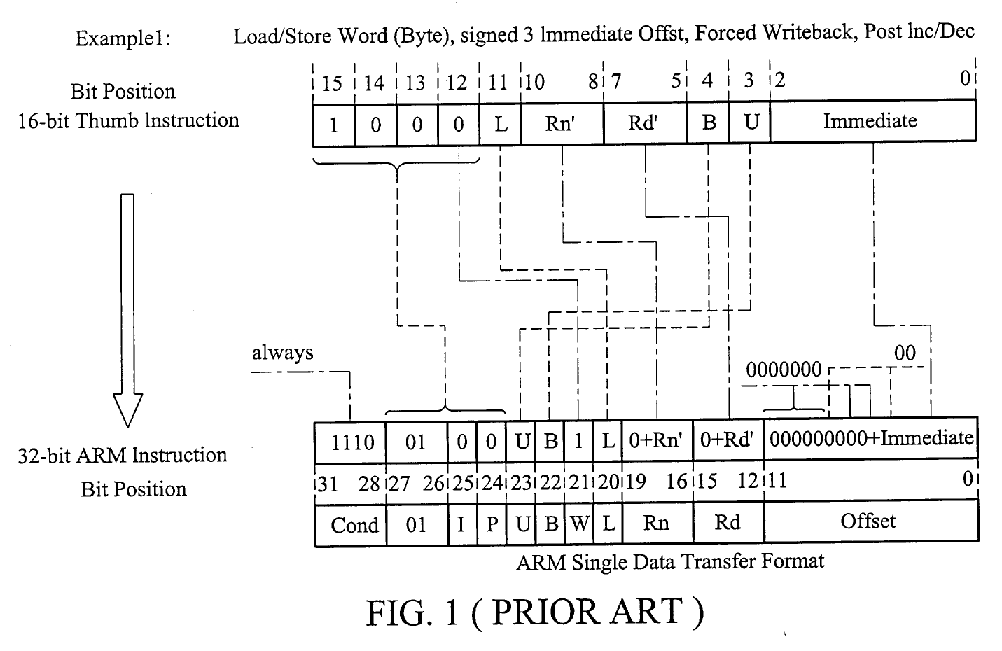

FIG. 2 schematically illustrates a second example of the typical 16-to-32-bit instruction mapping;

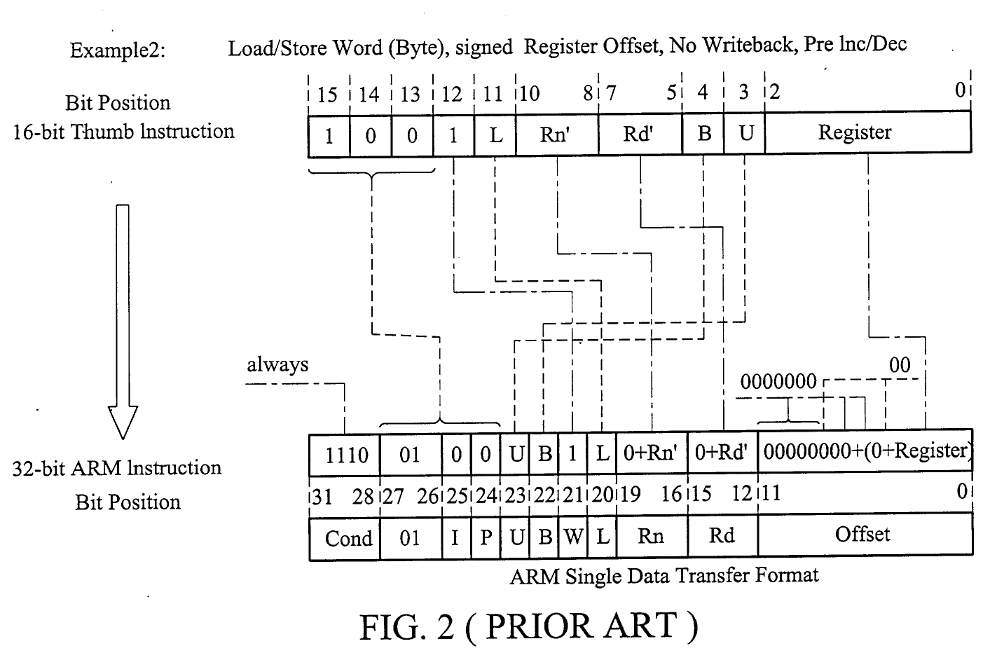

FIG. 3 is an example of a 32-bit instruction set including the 32-bit instruction in FIGS. 1 and 2;

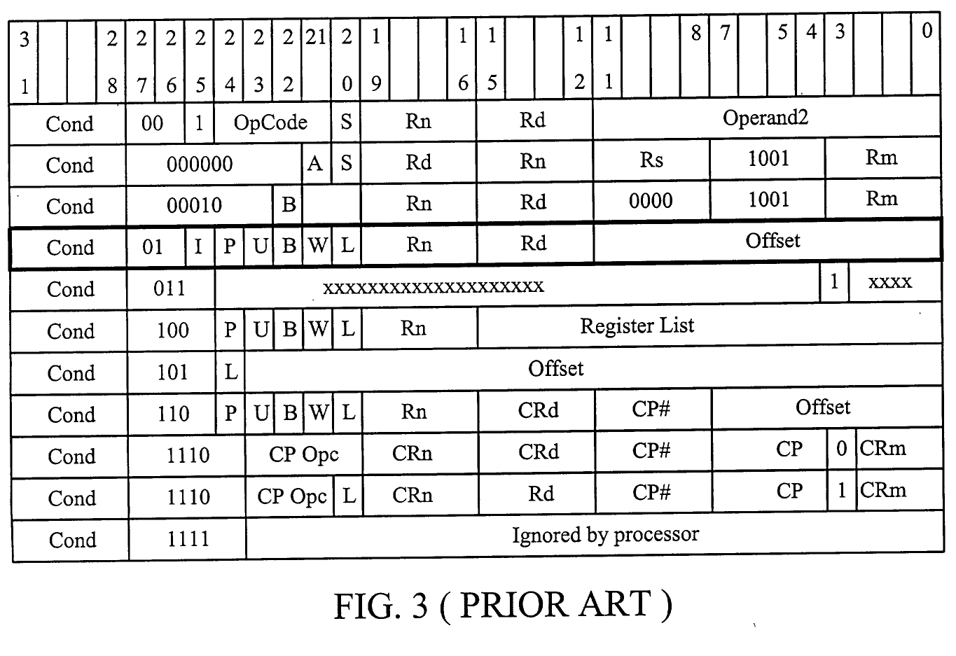

FIG. 4 is a schematic diagram of a typical ARM instruction decoding architecture;

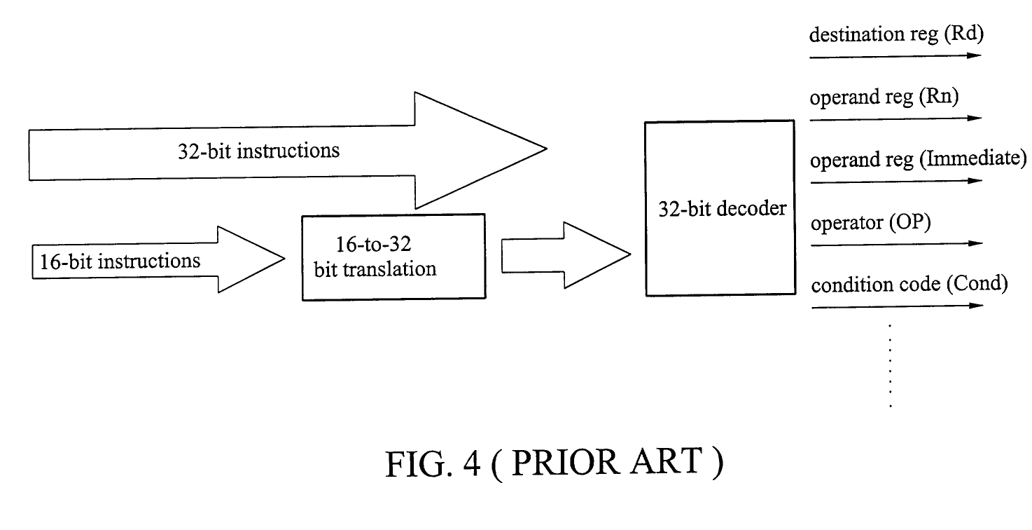

FIG. 5 is a flowchart of an instruction decoding method according to the invention;

FIG. 6a schematically illustrates an example for the re-assigning step of FIG. 5 according to the invention;

FIG. 6b schematically illustrates a portion of minor-opcode types of the example in FIG. 6a according to the invention;

FIG. 6c schematically illustrates a 24-bit mode of the re-assignment of FIG. 6a according to the invention; and

FIG. 7 is a schematic diagram of an instruction decoding architecture according to the invention.

### DETAILED DESCRIPTION OF THE INVENTION

The following numbers denote the same elements throughout the description and drawings.

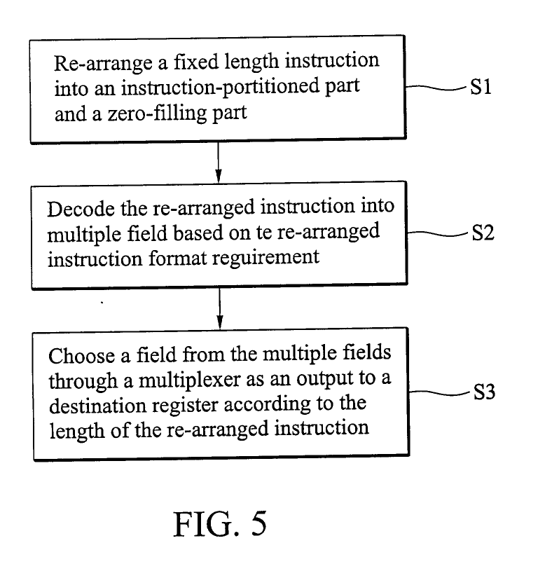

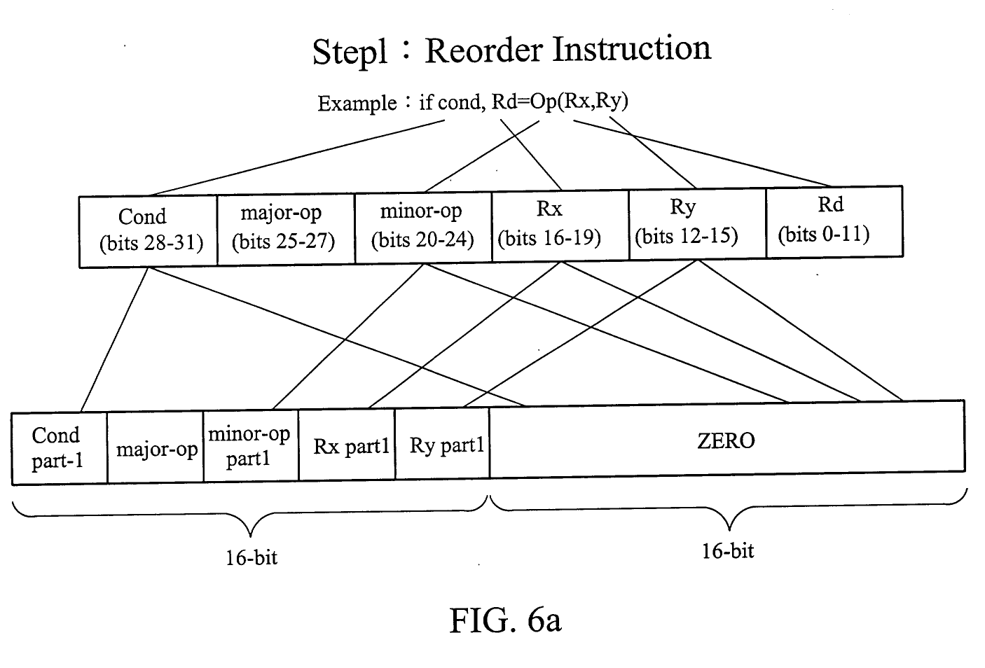

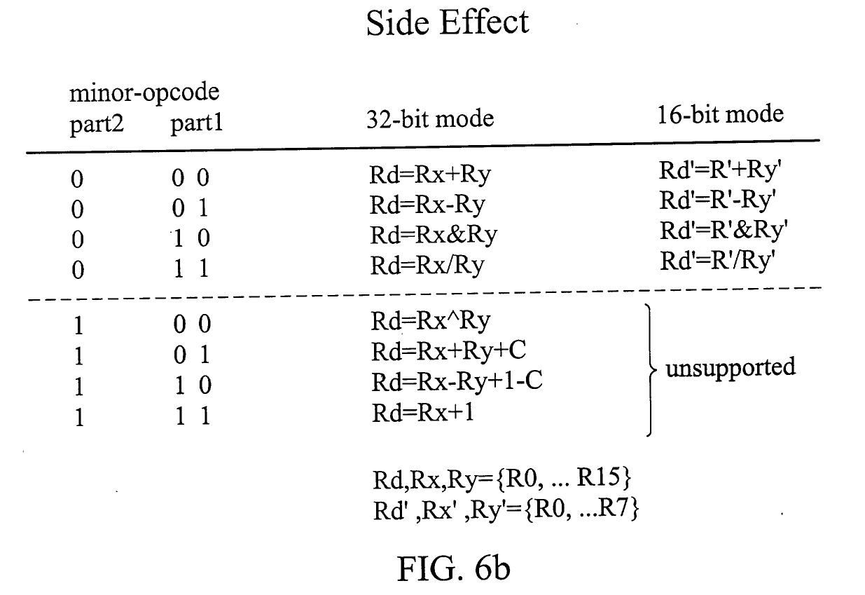

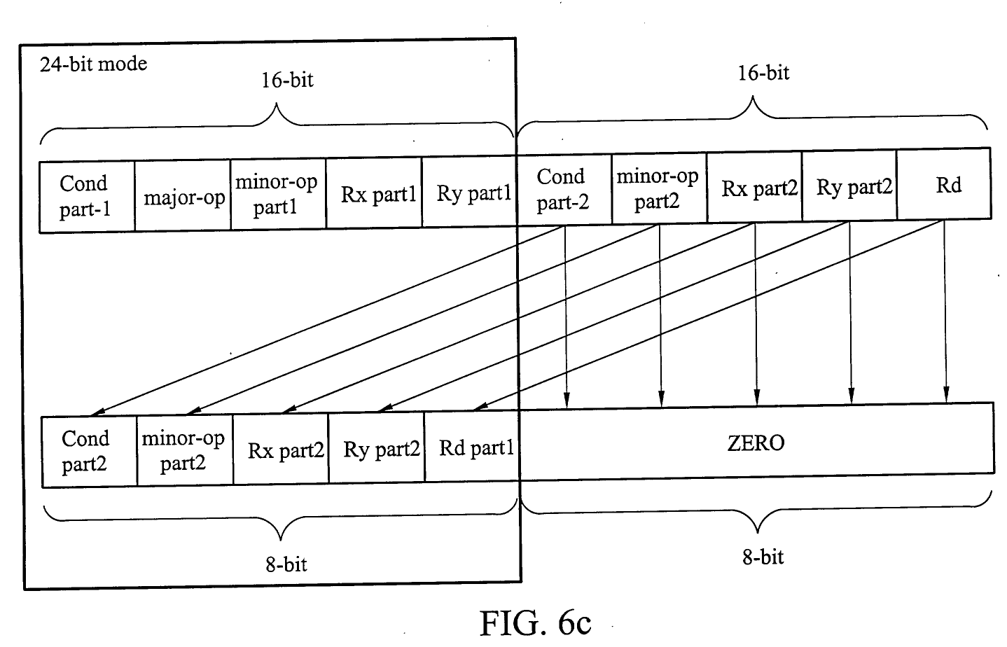

FIG. 5 is a flowchart of an instruction decoding method according to the invention. In FIG. 5, the decoding method includes the steps of: rearranging a fixed length instruction into an instruction partitioned part and a zero-filling part (S1); decoding the rearranged instruction as multiple fields based on the rearranged instruction format requirement (S2); and choosing one field from the multiple fields through a multiplexer as an output to the destination register according to the length of the instruction-partitioned part (S3). As shown in FIG. 5, step S1 can further include the steps of partitioning a fixed length instruction into multiple sub-instruction parts and re-positioning the multiple sub-instruction parts in the fixed length instruction by a high-low order so that the fixed length instruction can be divided into an instruction partitioned part and a zero-filling part. The description is given with reference to FIGS. 6a-6c by an instruction example “if cond, Rd=Op(Rx, Ry)” with a 32-bit mode. As shown in FIG. 6a, according to the ARM instruction format requirements, this instruction “if cond, Rd=Op(Rx, Ry)” generally includes conditional field (Cond), major-opcode (major-op), minor-opcode (minor-op), destination register (Rd), x register (Rx) and y register (Ry). The conditional field indicates the instruction execution condition such as “1110”=always. The major-opcode indicates the instruction execution format such as “001”=immediate format (absolutely addressing). The minor-opcode indicates an instruction operator for execution (see FIG. 6b). The destination register indicates the instruction execution result stored in the destination register. The x and y registers indicate two instruction operands stored in x- and y-registers for execution (see FIG. 6b). In this case, the destination register, the x register and the y register had better select from ARM registers R0-R13 that are general purpose registers because register R14 is dedicated to holding the address of the return point to make writing subroutines easier and register R15 is the program counter. For a 16-bit mode, the re-arrangement will first partition the Cond, minor-op, Ry and Ry or Rd into two parts, namely part1 and part2, and then position the part1 and the major-op in the upper-16 bits of the cited instruction. Later in the decoding step, the lower-16 bits of the cited instruction will be filled by zero. An example of partitioning the cited minor-opcode into part1 and part2 is shown in FIG. 6b where the lower two bits are as part1 and the highest one bit is as part2. If the operands are 16 bits, a 24-bit mode may be adopted by further partitioning the Rd into part1 and part2 and encoding the Cond part2, the minor-op part2, the Rx part2, the Ry part2 and Rd part1 in the upper-half bits of the lower-16 bits of the instruction so as to form the 24-bit mode as shown in FIG. 6c. Also, the remaining 8 bits of the cited instruction will be filled by zero in the decoding step.

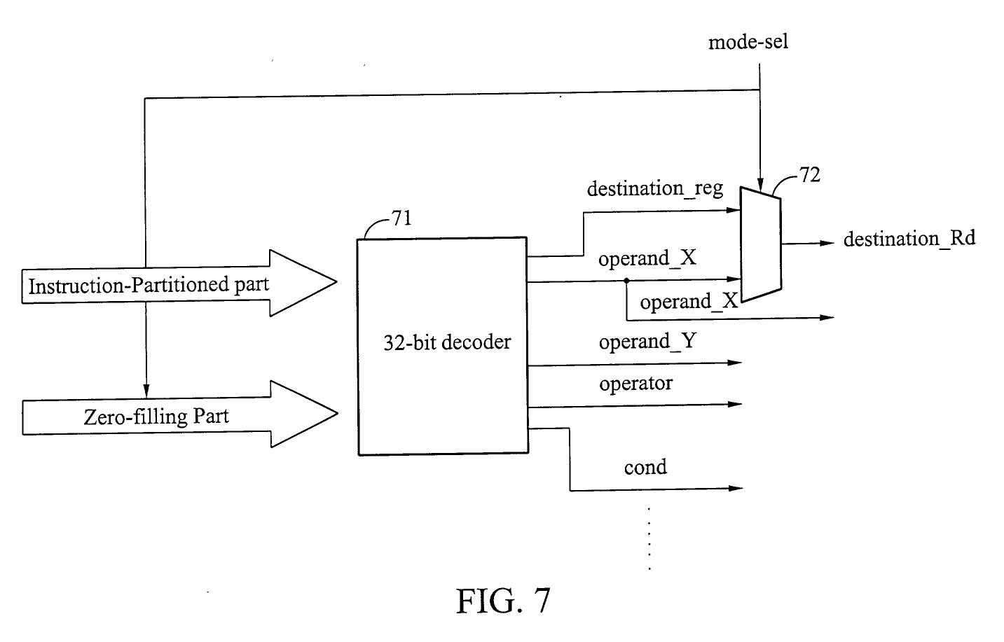

FIG. 7 is schematic diagram of an instruction decoding architecture according to the invention. As shown in FIG. 7, steps S2 and S3 in FIG. 5 are performed by this instruction decoding architecture that includes a customized decoder 71 for S2 and a multiplexer 72 for S3.

In step S2, the decoder 71 receives the rearranged instruction including the instruction-partitioned part and the zero-filling part, performs the zero-filling action according to the received zero-filling part, and decodes the received instruction-partitioned part into multiple fields according to the rearranged instruction format requirement, then outputs the multiple fields, wherein the multiple fields include destination_reg, operand_X, operand_Y, operator and cond based on the rearranged instruction format requirement. It is noted that the cited destination_reg, operand_X, operand_Y, operator and cond may be part of the fixed length instruction after the re-arrangement.

In step S3, the multiplexer 72 chooses one field from the multiple fields as the destination register's content according to a mode-sel with respect to the length of the desired instruction part. In a two-mode (16- and 32-bit) case, the mode-sel with one bit cooperating to, for example, the 2-1 multiplexer 72 is adopted at operation. When the desired instruction part has n=16, it represents the mode-bit as the 16-bit mode, and thus the mode-bit inputs a logic, for example, of 0 to activate the multiplexer 72 outputting the operand_X as the destination_Rd. When the desired instruction part has n=32, it represents the mode-bit as the 32-bit mode, and thus the mode-bit inputs a logic, for example, of 1, to activate the multiplexer 72 outputting the destination_reg as the destination_Rd. Likely, in a practical design, the mode-sel and the multiplexer can vary as desired. For example, the mode-sel can be a two-bit gray level signal to represent 8-, 16-, 24-, and 32-bit modes and accordingly the multiplexer can be a 4-1 multiplexer or the like. Also, the decoding architecture is machine-dependent.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A decoding method for a multi-length-mode instruction set, comprising the steps of:
rearranging a fixed length instruction into an instruction-partitioned part and a zero-filling part;
decoding the rearranged instruction as multiple fields based on the rearranged instruction format requirement; and
choosing one field from the multiple fields through a multiplexer as the destination register's content according to the length of the desired instruction part.

2. The decoding method of claim 1, wherein the total bit number of the desired instruction part and the zero-filling part are equal to that of the fixed length instruction.

3. The decoding method of claim 2, wherein the fixed length instruction has a 32-bit length.

4. The decoding method of claim 1, wherein the decoding step further comprises performing a zero-filling action according to the zero-filling part while decoding the rearranged instruction.

5. The decoding method of claim 1, wherein the multiple fields comprise a destination register field, a first operand register field, a second operand register field, a major operator, a minor operator, and a conditional field.

6. The decoding method of claim 5, wherein in the choosing step, the one field is the destination register field when the length of the desired instruction part is 32 bits.

7. The decoding method of claim 5, wherein in the choosing step, the one field is the first operand register field when the length of the desired instruction part is 24 bits.

8. The decoding method of claim 5, wherein in the choosing step, the one field is the first operand register field when the length of the desired instruction part is 16 bits.

9. The decoding method of claim 5, wherein in the choosing step, the one field is the second operand register field when the length of the desired instruction part is 24 bits.

10. The decoding method of claim 5, wherein in the choosing step, the one field is the second operand register field when the length of the desired instruction part is 16 bits.

11. A decoding method for a multi-length-mode instruction set, comprising the steps of:
partitioning a fixed length instruction into multiple sub-instruction parts;
re-positioning the multiple sub-instruction parts in the fixed length instruction by a high-low order so that the fixed length instruction is divided into an instruction-partitioned part and a zero-filling part;
receiving the instruction-partitioned part and the zero-filling part using a customerized decoder;
performing the zero-filling action according to the received zero-filling part;
decoding the received instruction-partitioned part into multiple fields according to the received instruction-partitioned part's format requirement; and
choosing one field from the multiple fields through a multiplexer as the destination register's content according to the length of the desired instruction part.

12. The decoding method of claim 11, wherein the total bit number of the desired instruction part and the zero-filling part are equal to that of the fixed length instruction.

13. The decoding method of claim 12, wherein the fixed length instruction has 32-bit length.

14. The decoding method of claim 11, wherein the multiple fields comprise a destination register field, a first operand register field, a second operand register field, a major operator, a minor operator, and a conditional field.

15. The decoding method of claim 14, wherein in the choosing step, the one field is the destination register field when the length of the desired instruction part is 32 bits.

16. The decoding method of claim 14, wherein in the choosing step, the one field is the first operand register field when the length of the desired instruction part is 24 bits.

17. The decoding method of claim 14, wherein in the choosing step, the one field is the first operand register field when the length of the desired instruction part is 16 bits.

18. The decoding method of claim 14, wherein in the choosing step, the one field is the second operand register field when the length of the desired instruction part is 24 bits.

19. The decoding method of claim 14, wherein in the choosing step, the one field is the second operand register field when the length of the desired instruction part is 16 bits.
